(19) United States
(12) Patent Application Publication
(10) Pub. No.: US 2014/0263018 A1
(43) Pub. Date: Sep. 18, 2014

(54) TETHER-RETAINED DIALYZER PORT CAP AND DIALYZER INCLUDING SAME

(71) Applicant: FRESENIUS MEDICAL CARE HOLDINGS, INC., Waltham, MA (US)

(72) Inventor: Gregg Fuhriman, Concord, CA (US)

(73) Assignee: FRESENIUS MEDICAL CARE HOLDINGS, INC., Waltham, MA (US)

(21) Appl. No.: 13/840,541

(22) Filed: Mar. 15, 2013

(51) Int. Cl. B01D 61/30; B65D 55/16

(52) U.S. Cl. CPC B01D 61/30; B65D 55/16
USPC 210/232; 49/463

(57) ABSTRACT

A tether-retained dialyzer port cap has a port cap which is removably connectible to a port of a dialyzer to block the port, and a retention strap that has a first looped end, a second looped end, and having an elongate portion integrally linking the first looped end and the second looped end. The first looped end is adapted to engage around curved sidewalls defining a circumferential surface of a dialyzer component, and the second looped end is i) integrally molded to the port cap, or ii) adapted to fit around an outer surface of a cap stem of the port cap. A dialyzer with the tether-retained dialyzer port cap further is described. The tether-retained dialyzer port cap tethers a port cap to a dialyzer for safe and convenient retention of the cap near the dialyzer for ready re-use to reseal a port of a used dialyzer for disposal handling.

### FIELD OF THE INVENTION

The present invention relates to a dialyzer port cap with a tethering retainer. The present invention further relates to a dialyzer which includes the port cap with a tethering retainer.

### BACKGROUND OF THE INVENTION

A dialyzer is a filter device which can be used by patients with kidney disease who suffer from the adverse effects of toxin build-up in their blood. A conventional dialyzer, such as a hemodialysis dialyzer, has blood ports for introduction and discharge of blood flow from the dialyzer device during a dialysis treatment. Blood can be passed through filtration means, such as hollow fiber bundles or membranes, arranged within a hollow cylindrical-shaped tube portion of the dialyzer between the blood introduction and discharge ports. The dialyzer typically further includes ports for introduction and discharge of dialysate fluid to and from the device. Dialyzers and components thereof of these types are shown, for example, in U.S. Pat. Nos. 3,691,068, 4,324,662, and 6,830,685, all of which are incorporated in their entireties by reference herein.

After assembly and before using a dialyzer, removable re-usable caps have been connected to blood ports of the device to block the ports, and thus help maintain the as-assembled sterile condition of the internal components and surfaces of the dialyzer for use. These port caps are removed when the dialyzer is to be used in a dialysis treatment. After finishing a dialysis treatment, residual fluids may remain inside the dialyzer. For disposal and disposal handling of the used dialyzer, the caps need to be re-installed on the ports to prevent potential residual fluid flow back out of the dialyzer through ports of the dialyzer, such as the blood ports. Some dialyzers include small plastic threaded caps, for example, that cover the shunt line blood ports to block fluid flow through the port. When not installed in a dialyzer port, these caps are loose separable parts from the dialyzer itself. When the user unscrews and removes the caps from the dialyzer ports, the removed caps typically are retained somewhere nearby to be available for re-use to re-cap a port of a used dialyzer for handling and disposal. The loose caps, however, are often set on the dialysis machine or on other surfaces apart from the dialyzer during a dialysis treatment, but can easily roll or fall off, land on the floor, or otherwise become lost or difficult to re-locate when later needed. Furthermore, caps left laying about may cause unsanitary conditions, especially in cases of re-used dialyzers by patients.

There is a need for retention means for dialyzer port caps which can keep them in connected proximity to the dialyzer when they are disconnected from a port line during use of the dialyzer, and which can be readily accessible for re-use to recap the dialyzer ports after completing a use of the dialyzer.

### SUMMARY OF THE INVENTION

A feature of the present invention is a dialyzer port cap with a cap retainer that can tether a port cap to a dialyzer for safe and convenient retention of the cap, when unscrewed from the port, near the dialyzer for ready re-use to reseal the port of the used dialyzer for disposal.

A further feature of the present invention is a dialyzer which includes such a tether-retained port cap.

To achieve these and other advantages and in accordance with the purposes of the present invention, as embodied and broadly described herein, the present invention relates, in part, to a tether-retained dialyzer port cap comprising a port cap removably connectible to a port of a dialyzer, and a retention strap having a first looped end, a second looped end, and having an elongate portion integrally linking the first looped end and the second looped end. The first looped end is adapted to engage around curved sidewalls defining a circumferential surface of a dialyzer component, and the second looped end is i) integrally molded to the port cap, or ii) adapted to fit around an outer surface of a cap stem of the port cap, wherein the second looped end is laterally translatable along the cap stem that is connectible to a port of a dialyzer from a free end thereof to an opposite cap head of the port cap.

The present invention further relates to a dialyzer with a tether-retained dialyzer port cap, comprising a cylindrical tubular portion, flange caps at opposite ends of the cylindrical tubular portion, at least one port extending from said flange cap or cylindrical tubular portion, a port cap removably connectible to the at least one port of the dialyzer, and a retention strap having a first looped end, a second looped end, and having an elongate portion integrally linking the first looped end and the second looped end. The first looped end is adapted to engage around curved sidewalls defining a circumferential surface of a dialyzer component, and the second looped end is i) integrally molded to the cap, or ii) adapted to fit around an outer surface of a cap stem of the cap, wherein the second looped end is laterally translatable along the cap stem that is connectible to a port of a dialyzer from a free end thereof to an opposite cap head of the port cap.

It is to be understood that both the foregoing general description and the following detailed description are exemplary and explanatory only and are intended to provide a further explanation of the present invention, as claimed.

The accompanying figures, which are incorporated in and constitute a part of this application, illustrate various features of the present invention and, together with the description, serve to explain the principles of the present invention. The features depicted in the figures are not necessarily drawn to scale. Similarly numbered elements in different figures represent similar components unless indicated otherwise.

### BRIEF DESCRIPTION OF THE DRAWINGS

FIG. 1 shows a side view of a dialyzer which has tether-retained port caps according to an example of the present application.

FIG. 2 shows a retention strap for tethering a cap to a dialyzer according to an example of the present application.

FIG. 3 shows an enlarged view of an end of the dialyzer of FIG. 1 with the port cap and an attached smaller looped end of a retention strap removed from the dialyzer port and an opposite larger looped end of the retention strap fitted around a cylindrical tubular portion of the dialyzer according to an example of the present application.

FIG. 4 shows an enlarged view of an end of the dialyzer of FIG. 1 with the port cap and an attached smaller looped end of the retention strap of a tether-retained dialyzer port cap removed from the dialyzer port and an opposite larger looped end of the retention strap detached from the dialyzer according to an example of the present application.

FIG. 5 shows an enlarged view of an end of the dialyzer with the port cap and an attached smaller looped end of the retention strap of a tether-retained dialyzer port cap screwed into the dialyzer port and an opposite larger looped end of the retention strap attached to an end of the dialyzer according to an example of the present application.

FIG. 6 shows a dialyzer with the tether-retained dialyzer port cap attached to an end of the dialyzer according to an example of the present application.

FIG. 7 shows an enlarged view of an end of the dialyzer of FIG. 1 with a port cap of a tether-retained dialyzer port cap removed from the dialyzer port and an opposite looped end of the tether-retained dialyzer port cap fitted on a neck of a blood port of the dialyzer according to an example of the present application.

FIG. 8 shows a port cap having an integrally molded retention strap attached at one thereto and an opposite looped end which can be removably attached to an end of the dialyzer according to an example of the present application.

FIG. 9 shows an exploded isometric view of the filter device of FIG. 1 according to an example of the present application.

### DETAILED DESCRIPTION OF THE INVENTION

An integrated retainer feature for dialyzer port caps is provided wherein caps can remain connected to a dialyzer even when the caps are unscrewed or otherwise disconnected from a dialyzer port, such as a shunt line port. The disconnected caps then can hang or suspend from the dialyzer via the retainer while the device is in use during a dialysis treatment, and therefore cannot fall to floor or otherwise get lost before the caps are used to reseal the dialysis ports of a used dialyzer.

A tether-retained dialyzer port cap is provided that can have a port cap removably connectible to a port of a dialyzer, and a retention strap that has a first looped end used for making a connection to the dialyzer, a second looped end for making a connection to the port cap, and having an elongate portion integrally linking the first looped end and the second looped end. The first looped end of the tether-retained dialyzer port cap can be structured to engage around curved sidewalls defining a circumferential surface of a dialyzer component, such as a cylindrical dialyzer tube or a port neck. The second looped end of the retention strap of the tether-retained dialyzer port cap can be structured to be connected to the cap with a first or second configuration. As a first configuration, the second looped end of the retention strap can be integrally molded to the port cap. In a second configuration, the retention strap can be a separable discrete part with respect to the port cap. In the separable configuration with respect to the cap, the second looped end of the retention strap can be adapted to fit around an outer surface of a cap stem of the port cap. The cap stem can include an externally threaded portion adapted to threadingly screw into and out of internal threading on a port of a dialyzer. The second looped end can be sized to be fitted around and translatable laterally along a cap stem of the cap from a free end towards an opposite cap head of the cap. The cap stem can be connectible to a port of a dialyzer, such as via screw-threading. The second looped end can be fitted flush against the cap head, such as in a sealing washer-like engagement. These configurations of the tether-retained dialyzer port cap permit a port cap that is disconnected from a dialyzer port during use of the dialyzer to be tethered to the dialyzer for safe retention near the dialyzer for ready re-use to reseal a port of a used dialyzer for disposal. The end of the retainer that is connected with the cap can be a loop sized to fit over the cap stem and manually translatable back to the cap head while mounted around the cap stem. For example, the loop attachable to the cap can be configured as seal washer that is integrally attached to an elongate strap that is integrally connected at its opposite end to a dialyzer-attachable loop.

The opposite first looped end of the retention strap of the tether-retained dialyzer port cap that is used for making connection to the dialyzer can have a loop that is fittable over any cylindrical external circumferential surface of dialyzer. These circumferential mounting surfaces of the dialyzer for the first looped end of the retention strap can include, for example, a circumferential surface area of the dialyzer tube located between a dialysate side port and a flanged cap connected to the end of the dialyzer tube. The loop of the first looped end of the port cap retainer can be sized large enough to be fittable over the external circumferential surface of a cylindrical tubular portion of the dialyzer between a flange cap and a dialysate side port. Another mounting surface for the first looped end of the retention strap can be the external surface of a neck of a shunt line (blood) port in which the cap is connected (e.g., screwed into).

The elongate portion of the retention strap which integrally links the first looped end and the second looped end can be any material which can hang from or be flexed away from the dialyzer when a cap is disconnected from a port of the dialyzer, and which is flexible enough that the retention strap can be flexed or bent sufficiently to permit a cap to be connected to a port while the loop at the opposite of the retention strap is connected to the dialyzer. The retention strap can be polymeric material, or other materials such as food grade plastics or materials. The polymeric material can be, for example, any moldable or castable thermoplastic or elastomeric material which includes the indicated physical properties, such as polyolefin, polyurethane, polyester, rubber, or other polymeric materials. The polyolefin can be, for example, polypropylene (e.g., polypropylene homopolymer or copolymer). The retention strap can have an elongate portion having any length, width, and thickness sufficient to permit the looped ends to by manipulated towards and away from the dialyzer, such as indicated, and permit a cap connected at the second looped end thereof to be screwed or unscrewed from a port without the strap twist-binding.

As indicated, a tether-retained dialyzer port cap of the present invention can be used with a dialyzer, such as a hemodialysis dialyzer. As shown in FIG. 1, for example, dialyzer 100 has tether-retained dialyzer port cap 1100 which can combine a retention strap 110 attachable at one end to a port cap 112 and an opposite end to the dialyzer at the right-side end of the dialyzer 100. The retention strap 110′ (which can have the same structure as retention strap 110) is shown in a disconnected configuration with respect to a cap 112 from port 118 at the left-side end of the dialyzer 100. An opposite end of the retention strap 110′ remains attached to that same end of the dialyzer. The combined strap 110′ and cap 112 together comprise a tether-retained dialyzer port cap 1100′. In FIG. 1, the retention strap portions 110 and 110′ of the tether-retained dialyzer port caps 1100 and 1100′ are traced with dashed lines to simplify this view. Additionally discussed figures herein provide further information on the structure of the retention strap and cap of the tether-retained dialyzer port caps. During use of the dialyzer 100, the caps typically are disconnected from their ports and left hanging from both ends of the dialyzer via the retention straps 110 and 110′ in the manner shown for tether-retained dialyzer port cap 1100′. Apart from the tether-retained dialyzer port caps 1100 and 1100′, the dialyzer 100 can include conventional components to dialyzers, although not limited thereto. That is, the tether-retained dialyzer port cap of the present invention can be retro-fitted onto an existing dialyzer design or can be used with different dialyzer configurations which still include port caps and loop engageable exterior surfaces.

The dialyzer 100 can include, for example, in addition to tether-retained dialyzer port caps 1100 and 1100′, a large number of microfibers 104 encased in a housing 102 (not shown in FIG. 6 to simplify that view). Housing 102 can be a hollow cylinder which is open at both ends. In such a design, thousands of the hollow semipermeable microfibers 104 carry blood in a pathway through one set of open ends of each microfiber 104, through the interior of each microfiber 104, and exiting out of the other open end of each microfiber 104. As shown in FIG. 1, thousands of the hollow semipermeable microfibers 104 carry blood in a pathway that enters from one end through a first blood inlet/outlet port 118 to the opposite end and out through a second blood inlet/outlet port 118 so that blood flows through the interior of each microfiber 104 in a first direction. Dialysate inlet/outlet ports 111 are present on opposite ends of housing 102. A first dialysate inlet/outlet port 110 carries dialysate in a pathway into housing 102, the dialysate flows through housing 102 in a countercurrent direction to the blood flow and in the space between each microfiber 104, and a second dialysate inlet/outlet port 111 carries the dialysate out of housing 102. The material exchange thus takes place across the semipermeable membrane that is the walls of each microfiber 104. Label 114 can be a preprinted information label that can be applied after assembly. The cap 112 can screw into each blood inlet/outlet port 118, such as after sterilization, and is utilized to ensure an uncontaminated fluid pathway and is typically not removed until the technician is ready to connect the blood lines. The cap 112, when connected to port 118, can block fluid flow via the port. The dialyzer 100 can be a single use disposable device, wherein the cap 112 can be needed for screwing back into a port after use of the dialyzer to block possible flow of residual fluid out from the dialyzer when uninstalled from a dialysis machine for disposal and related handling. The tethering cap retainer device of the present invention makes it possible to keep the cap conveniently attached directly to the dialyzer for convenient retrieval for re-use to close a port of a used dialyzer with the cap.

It is also important to note that most dialyzers, or artificial kidneys, are intended to be single use, meaning they are disposed of or recycled after an individual dialysis treatment. Nevertheless some dialyzers are intended for reuse, meaning that the same dialyzer may be used for multiple treatments of the same patient. Such reuse dialyzers are cleaned, stored and capped between uses. Reuse dialyzers are especially important for patients that have negative reactions to “new” dialyzers, a rare event. This invention is therefore particularly useful for reuse dialyzers where caps could conceivably be contaminated or cause contamination if stored improperly. This invention guarantees that the same cap is used on the same dialyzer and it is less like to be exposed to unsanitary surfaces.

The flange caps 106 and O-rings 119 of the dialyzer shown in FIG. 1 are described in more detail with respect to other figures herein. The design of the dialyzer 100 can produce a high surface area for material exchange in a relatively low volume device. For example, a dialyzer 100 may have about a 5-10 cm cylindrical diameter and about a 20-30 cm length, or other dimensions. A dialyzer with this geometry can accommodate a bundle of about 12,000 to 13,000 microfibers 104, or other amounts.

FIG. 2 shows a port cap retainer of the present invention which comprises retention strap 210. Retention strap 210 can be used for retention strap 110 and 110′ shown in FIG. 1. This retention strap 210 can be used as part of a tether-retained dialyzer port cap of the present invention which comprises a retention strap that is a separable discrete part with respect to the port cap and has a looped end which is attachable/detachable with the cap. The retention strap 210 has a first looped end 220 defining an opening 224 defined by inner ring-shaped circumferential surface 218. The inner surface 218 and opening 224 can define an opening diameter and shape sized to permit the first looped end 220 to physically engage around curved sidewalls defining a circumferential surface of a dialyzer component, such as a cylindrical dialyzer tube or a port neck. The looped end 220 may be sized slighter smaller than the outer diameter of a surface of the dialyzer and have sufficient elasticity to be able to be manually expanded enough to fit over the circumferential dialyzer surface and then removably compressively bias onto the surface. A second looped end 215 of the retention strap 210 can be provided on the opposite end of the strap 210 via an interlining elongate portion 212. The second looped end 215 of the retention strap 210 can have an opening 225 defined by inner ring-shaped surface 216. The inner ring-shaped surface 216 and opening 225 can define an opening diameter and shape sized to fit around an outer surface of a cap stem of the port cap. The second looped end 215 can be sized to be fitted around and translated laterally along a cap stem of a cap from a free end thereof towards an opposite cap head of the cap. The second looped end 215 can have a side surface 214, which can be a flat surface, which can be fitted flush against a cap head, such as in a sealing washer-like engagement therewith. The second looped end 215 can have an outer circumferential surface 213 which defines an overall diameter of the looped end 215. The openings 224 and 225 defined at the opposite looped ends of the retention strap can be circular or approximately circular, or may be other shapes. The openings 224 and 225 of the retention strap 110 typically are circular shaped, albeit typically in different circle sizes (diameters), where port caps to be used therewith have circular or substantially circular-profiled cap stems and the exterior surface of the dialyzer to which an opposite looped end is to be fitted has a circular or substantially circular shape.

FIG. 3 shows an enlarged view of the tether-retained dialyzer port cap 1100 at the right-side end of the dialyzer 100. The first looped end 220 of the retention strap 110/210 is fitted around dialyzer at a location between a flange cap 106 and dialysate port 111 of the dialyzer 100. The second looped end 215 of the retention strap 110/210 is fitted around an outer surface of a cap stem 128 of the port cap 112. The cap stem 128 can include an externally threaded portion adapted to threadingly screw into and out of internal threading on a port 118 of the dialyzer 100.

As shown in further detail in FIG. 4, the second looped end 215 of the retention strap 110/210 can be sized to be fitted around and translated laterally along the cap stem 128 of the cap 112 from a free end 130 thereof towards an opposite cap head 126 of the cap 112. The cap stem 128 can be connectible to the port 118 of dialyzer 100. The second looped end 215 can have a surface 214 which can be fitted flush against the cap head 126, such as in a sealing washer-like engagement. The outer circumferential surface 213 of the looped end 215 can be a size (diameter) sufficient to cover an opening 134 of port 118 which receives the cap 112. This can provide a seal between the cap 112 and port 118. As shown in FIG. 4, the cap stem 128 also may include a flange 122 over which the second looped end 118 can be pushed into abutment with the cap head 126.

FIG. 5 shows an end of the dialyzer 100 wherein the port cap 112 with an attached smaller looped end 215 of the retention strap 110/210 of the tether-retained dialyzer port cap 1100 is screwed into the dialyzer port 118 and an opposite larger looped end 220 of the retention strap 110/210 attached to an end of the dialyzer 100 at a location between flange cap 106 and dialysate port 111.

FIG. 6 shows the entire dialyzer 100 with the tether-retained dialyzer port cap 1100 attached to one of the ends of the dialyzer 100. The flange caps 106 can have circumferential internal threads 131, and the housing 102 can have circumferential external threads 133 near opposite longitudinal ends thereof, wherein the flange cap 106 can be connectible to the housing 102. The flange cap 106 can be manually or mechanically screwed onto (or off of) the threads 133 of the housing 102. Although the threads are only indicated for the flange cap and housing at one end of the device, both ends of the dialyzer 100 can have the indicated threaded configuration of these components.

FIG. 7 shows use of a different mounting surface on the dialyzer 100 for the first looped end 220 of the retention strap 110/210 of the tether-retained dialyzer port cap 1100 which can be the external surface 123 of a neck 127 of a shunt line (blood) port 118 in which the cap 112 can be connected (e.g., screwed into).

FIG. 8 shows a cap 112 having an integrally molded retention strap 810 which includes an elongate portion 812 integrally connected at one end to cap 112 and an opposite looped end 820 which can be removably attached to an end of the dialyzer 100. For this configuration, the elongate portion 812 of the retention strap 810 can be made long enough to permit the cap 112 to be rotated during screwing the cap 112 into or out of the port 118 without restriction.

FIG. 9 shows an exterior curved circumferential surface 109 of dialyzer 100 upon which a looped end (220/820) of the retention strap (110/810) of the tether-retained dialyzer port cap such as described above in relation to FIGS. 1-6 and 8 can be fitted or attached. The assembly of dialyzer 100 with the incorporation or retrofitting of the tether-retained dialyzer port caps 1100 and 1100′ can provided in any convenient manner. For example, the assembly of the dialyzer 100 can begin in a customary way. Open-ended housing 102 can be filled with a bundle of microfibers, such as microfibers 104 shown in FIG. 1, which extend in the longitudinal direction throughout the length of housing 102 and extending a short distance beyond each end. Housing 102 then can be positioned in a centrifuge to allow rotation about an axis perpendicular to the central longitudinal axis, wherein the axis of rotation extends through the midpoint of housing 102. A potting compound, such as potting compound 116 shown in FIG. 1, such as polyurethane or epoxy, then can be injected into dialysate inlet/outlet ports 111 on each end of housing 102, is spun in a centrifuge, and the fibers are effectively potted in the dialyzer. Alternatively, each end of housing 102 may be separately spin welded and injected in a two-step process. The centripetal force produced by the rotation in the centrifuge forces potting compound 116 to each end, where it sets and hardens. Housing 102 then can be removed from the centrifuge with the hardened potting compound 116 encasing the ends of each microfiber, such as a microfiber 104 shown in FIG. 1. Potting compound 116 and the encased microfibers, such as microfibers 104 shown in FIG. 1, at each end can be then cut through in a plane perpendicular to the central longitudinal axis of housing 102, and the longitudinal axes of the microfibers, to expose the interior channels of each microfiber. The result is that the ends of each microfiber, such as microfiber 104 shown in FIG. 1, are open for blood flow through the interior channels of each microfiber extending through housing 102, but the rest of the space surrounding each microfiber at both ends of housing 102 is filled with polyurethane, creating a seal between the blood and dialysate.

Still referring to FIG. 9, after the potting and cutting process, a flange cap 106 bearing port 118 can be attached to dialyzer 100. As indicated, the flange cap and housing can have threading to permit the flange caps to be screwed onto or from outer end surfaces of the housing. Before flange cap 106 is screwed onto the housing 102, one of the looped ends 220 of the retention strap of the tether-retained dialyzer port caps 1100 and 1100′ shown in FIG. 1 can be fitted onto exterior curved circumferential surface 109 of the dialyzer 100. As another design, flange cap 106 can be screwed onto the housing 102, and thereafter looped end of the retention strap of the tether-retained dialyzer port cap can be fitted over exterior circumferential surfaces of the dialyzer.

The dialyzer may include an O-ring 119 to assist in the sealing of the flange cap 106 to the housing 102. The O-ring may be positioned, for example, adjacent the leading part of the threaded portion of the flange cap and sized to sealingly fit over an outer end surface of the housing. Dialysate inlet/outlet port 111 in the walls of housing 102, which are toward but not at the very ends, remain open for dialysate flow there through. A dialysate line is connected to one dialysate inlet/outlet port 111 and a dialysate return line is connected to the other dialysate inlet/outlet port 111. The dialysate thus flows through the interior of housing 102 in the space surrounding the microfibers, such as microfibers 104 shown in FIG. 1, in one direction. Blood flows from an arterial blood line from a patient connected to a first blood inlet/outlet port 118, entering the exposed ends of each microfiber, such as microfiber 104 shown in FIG. 1, and flowing through the interior channels through the length of housing 102 in a countercurrent direction, and then out of the other exposed ends of each microfiber 104 and back to the patient through a venous blood line connected to a second blood inlet/outlet port 118. The blood is thus separated from the dialysate by the semipermeable membranes of the microfiber walls, which allow the transfer of liquids, toxins, and nutrients by solute diffusion and pressure gradients. After the completion of a dialysis treatment, the blood lines can be disconnected from the ports 118, and the tethered caps 112 shown in FIG. 1, which hang from the dialyzer via straps 110 and 110′ such as shown in FIG. 1, can be readily screwed back into the ports 118 to block them. The dialyzer 100 with the reconnected caps 112 can be conveniently and safely handled for disposal.

The present invention includes the following aspects/embodiments/features in any order and/or in any combination:

1. Tether-retained dialyzer port cap, comprising:

a port cap which is removably connectible to a port of a dialyzer; and

a retention strap having a first looped end, a second looped end, and having an elongate portion integrally linking said first looped end and said second looped end;
said first looped end adapted to engage around curved sidewalls defining a circumferential surface of a dialyzer component;
said second looped end is
   i) integrally molded to the port cap; or
   ii) adapted to fit around an outer surface of a cap stem of the port cap, wherein said second looped end is laterally translatable along the cap stem that is connectible to a port of a dialyzer from a free end thereof to an opposite cap head of the port cap.
      2. The tether-retained dialyzer port cap of any preceding or following embodiment/feature/aspect, wherein said retention strap, said first looped, and said second looped end comprising a single piece of polymeric material.
      3. The tether-retained dialyzer port cap of any preceding or following embodiment/feature/aspect, wherein said first looped end is adapted to compressibly engage around outer curved sidewalls defining a portion of a circumference of a dialyzer component.
      4. The tether-retained dialyzer port cap of any preceding or following embodiment/feature/aspect, wherein said second looped end defining an opening which has a diameter that is smaller than a diameter of the cap head.
      5. The tether-retained dialyzer port cap of any preceding or following embodiment/feature/aspect, wherein the port cap comprising a cap head and a cap stem, wherein the cap stem being threadingly connectible to a shunt port of a dialyzer.
      6. The tether-retained dialyzer port cap of any preceding or following embodiment/feature/aspect, wherein said second looped end is integrally molded to the port cap, wherein the retainer comprises a polymer.
      7. The present invention further relates to a dialyzer with a tether-retained dialyzer port cap, comprising:

a cylindrical tubular portion, flange caps at opposite ends of the cylindrical tubular portion, at least one port extending from said flange cap or cylindrical tubular portion;

a port cap which is removably connectible to said at least one port of said dialyzer;

a retention strap having a first looped end, a second looped end, and having an elongate portion integrally linking said first looped end and said second looped end;
said first looped end adapted to engage around curved sidewalls defining a circumferential surface of a dialyzer component;
said second looped end is
   i) integrally molded to the cap; or
   ii) adapted to fit around an outer surface of a cap stem of the cap, wherein said second looped end is laterally translatable along the cap stem that is connectible to a port of a dialyzer from a free end thereof to an opposite cap head of the port cap.
      8. The dialyzer of any preceding or following embodiment/feature/aspect, wherein said port cap remains connected to the dialyzer via said retention strap when said port cap is disconnected from a port of the dialyzer.
      9. The dialyzer of any preceding or following embodiment/feature/aspect, wherein the flange caps are removably connectible to the opposite ends of the cylindrical tubular portion.
      10. The dialyzer of any preceding or following embodiment/feature/aspect, wherein the flange caps are threadingly connectible to the opposite ends of the cylindrical tubular portion.
      11. The dialyzer of any preceding or following embodiment/feature/aspect, wherein the dialyzer comprises a first blood port and a second blood port at the respective flange caps, and a plurality of dialysate ports on the cylindrical tubular portion between the opposite ends thereof.
      12. The dialyzer of any preceding or following embodiment/feature/aspect, wherein a first port cap and a second port cap is removably connected to the first blood port and the second blood port respectively at said flange caps, and a first retention strap tethers the first port cap and a second retention strap tethers the second retention strap to the dialyzer.
      13. The dialyzer of any preceding or following embodiment/feature/aspect, wherein the cylindrical tubular portion further comprising a circumferential outer surface portion between a dialysate port and a nearest one of the opposite ends of the cylindrical tubular portion.
      14. The dialyzer of any preceding or following embodiment/feature/aspect, wherein the first looped end is fitted onto said circumferential outer surface portion of the cylindrical tubular portion.
      15. The dialyzer of any preceding or following embodiment/feature/aspect, wherein the first looped end is fitted onto an outer circumferential surface of said blood port.
      16. The dialyzer of any preceding or following embodiment/feature/aspect, wherein said retention strap, said first looped end, and said second looped end comprising a single piece of polymeric material.
      17. The dialyzer of any preceding or following embodiment/feature/aspect, wherein said first looped end is adapted to compressibly engage around outer curved sidewalls defining a circumferential surface of a dialyzer component.
      18. The dialyzer of any preceding or following embodiment/feature/aspect, wherein said second looped end defining an opening which has a diameter that is smaller than a diameter of the cap head.
      19. The dialyzer of any preceding or following embodiment/feature/aspect, wherein the port cap comprising a cap head and a cap stem, wherein the cap stem being threadingly connectible to a port of a dialyzer.
      20. The dialyzer of any preceding or following embodiment/feature/aspect, wherein said second looped end is integrally molded to said port cap and said retainer comprises a polymer.

The present invention can include any combination of these various features or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. Tether-retained dialyzer port cap, comprising:
a port cap which is removably connectible to a port of a dialyzer; and
a retention strap having a first looped end, a second looped end, and having an elongate portion integrally linking said first looped end and said second looped end;
said first looped end adapted to engage around curved sidewalls defining a circumferential surface of a dialyzer component;
said second looped end is
i) integrally molded to the port cap; or
ii) adapted to fit around an outer surface of a cap stem of the port cap, wherein said second looped end is laterally translatable along the cap stem that is connectible to a port of a dialyzer from a free end thereof to an opposite cap head of the port cap.

2. The tether-retained dialyzer port cap of claim 1, wherein said retention strap, said first looped, and said second looped end comprising a single piece of polymeric material.

3. The tether-retained dialyzer port cap of claim 1, wherein said first looped end is adapted to compressibly engage around outer curved sidewalls defining a portion of a circumference of a dialyzer component.

4. The tether-retained dialyzer port cap of claim 1, wherein said second looped end defining an opening which has a diameter that is smaller than a diameter of the cap head.

5. The tether-retained dialyzer port cap of claim 1 wherein the port cap comprising a cap head and a cap stem, wherein the cap stem being threadingly connectible to a shunt port of a dialyzer.

6. The tether-retained dialyzer port cap of claim 1, wherein said second looped end is integrally molded to the port cap, wherein the retainer comprises a polymer.

7. A dialyzer with a tether-retained dialyzer port cap, comprising:
a cylindrical tubular portion, flange caps at opposite ends of the cylindrical tubular portion, at least one port extending from said flange cap or cylindrical tubular portion;
a port cap which is removably connectible to said at least one port of said dialyzer;
a retention strap having a first looped end, a second looped end, and having an elongate portion integrally linking said first looped end and said second looped end;
said first looped end adapted to engage around curved sidewalls defining a circumferential surface of a dialyzer component;
said second looped end is
i) integrally molded to the cap; or
ii) adapted to fit around an outer surface of a cap stem of the cap, wherein said second looped end is laterally translatable along the cap stem that is connectible to a port of a dialyzer from a free end thereof to an opposite cap head of the port cap.

8. The dialyzer of claim 7, wherein said port cap remains connected to the dialyzer via said retention strap when said port cap is disconnected from a port of the dialyzer.

9. The dialyzer of claim 7, wherein the flange caps are removably connectible to the opposite ends of the cylindrical tubular portion.

10. The dialyzer of claim 7, wherein the flange caps are threadingly connectible to the opposite ends of the cylindrical tubular portion.

11. The dialyzer of claim 9, wherein the dialyzer comprises a first blood port and a second blood port at the respective flange caps, and a plurality of dialysate ports on the cylindrical tubular portion between the opposite ends thereof.

12. The dialyzer of claim 11, wherein a first port cap and a second port cap is removably connected to the first blood port and the second blood port respectively at said flange caps, and a first retention strap tethers the first port cap and a second retention strap tethers the second retention strap to the dialyzer.

13. The dialyzer of 12, wherein the cylindrical tubular portion further comprising a circumferential outer surface portion between a dialysate port and a nearest one of the opposite ends of the cylindrical tubular portion.

14. The dialyzer of claim 12, wherein the first looped end is fitted onto said circumferential outer surface portion of the cylindrical tubular portion.

15. The dialyzer of claim 12, wherein the first looped end is fitted onto an outer circumferential surface of said blood port.

16. The dialyzer of claim 7, wherein said retention strap, said first looped end, and said second looped end comprising a single piece of polymeric material.

17. The dialyzer of claim 7, wherein said first looped end is adapted to compressibly engage around outer curved sidewalls defining a circumferential surface of a dialyzer component.

18. The dialyzer of claim 7, wherein said second looped end defining an opening which has a diameter that is smaller than a diameter of the cap head.

19. The dialyzer of claim 7 wherein the port cap comprising a cap head and a cap stem, wherein the cap stem being threadingly connectible to a port of a dialyzer.

20. The dialyzer of claim 7, wherein said second looped end is integrally molded to said port cap and said retainer comprises a polymer.
